(19) United States
(12) Patent Application Publication
(10) Pub. No.: US 2007/0183051 A1
(43) Pub. Date: Aug. 9, 2007

(54) ANTIREFLECTION FILM FORMING METHOD, AND SUBSTRATE TREATING APPARATUS

(76) Inventors: Osamu Tamada, Kyoto (JP); Masakazu Sanada, Kyoto (JP); Tomohiro Goto, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/670,042

(22) Filed: Feb. 1, 2007

(30) Foreign Application Priority Data
Feb. 2, 2006 (JP) JP2006-026078

(51) Int. Cl. G02B 1/10

(52) U.S. Cl. 359/582

(57) ABSTRACT

A substrate is first spin-coated with an antireflection film material is carried out to the substrate to form antireflection film on the substrate. Next, a mixed solvent of HMDS and xylene is supplied in a predetermined quantity to the upper surface of the antireflection film, and is spin-dried in this state. The mixed solvent effects surface modifying treatment to reduce a hydrogen bonding component of surface energy of the antireflection film. Subsequently, the substrate receives heat treatment. This completes formation of the antireflection film on the substrate. As a result, the antireflection film has increased adhesion energy in water with respect to resist film, without impairing essential characteristics of the antireflection film.

### BACKGROUND OF THE INVENTION

(1) Field of the Invention

This invention relates to antireflection film forming methods and substrate treating apparatus for forming antireflection film on semiconductor wafers, glass substrates for liquid crystal displays, glass substrates for photomasks, or substrates for optical disks (hereinafter called simply “substrates”). More particularly, the invention relates to a technique for increasing adhesion energy in a liquid between antireflection film and resist film formed on the surface of the antireflection film.

(2) Description of the Related Art

In photolithography, BARC (Bottom Anti-Reflection Coating) method is used to form antireflection film under photoresist film in order to reduce standing wave and halation occurring in time of exposure. In order to use this BARC method, a substrate treating apparatus includes an antireflection film forming block along with a resist film forming block and a developing block. A substrate under treatment is first loaded into the antireflection film forming block where antireflection film is formed on the substrate, and then resist film is formed on the surface of the antireflection film in the resist film forming block. Thereafter the substrate is transported to an external apparatus separate from the treating apparatus and acting as an exposing apparatus (stepper) to be exposed therein. Then, the substrate is returned to the treating apparatus to be developed in the developing block, thereby resolving a resist pattern on the substrate (as disclosed in Japanese Unexamined Patent Publication No. 2004-319767, for example).

The conventional apparatus with such a construction has the following drawback.

With an increasingly refined structure today, resist patterns have large aspect ratios, resulting in an inconvenience of causing a pattern collapse in time of development. It is known that the pattern collapse can take place in a number of different modes. In a liquid such as a developer or deionized water used to wash away the developer, for example, deionized water or other liquid can infiltrate into an interface between the resist pattern and antireflection film, causing the resist pattern to peel off the antireflection film, for example.

To avoid such pattern collapse, an attempt has been made to improve the material of antireflection film itself. However, this measure requires a change in the composition of antireflection film, which hampers maintenance of certain essential characteristics of the antireflection film such as reflection preventing performance.

### SUMMARY OF THE INVENTION

This invention has been made having regard to the state of the art noted above, and its object is to provide antireflection film forming methods and substrate treating apparatus for improving adhesion between antireflection film formed on a substrate and resist film formed on the surface of the antireflection film, without impairing the characteristics of the antireflection film, thereby to inhibit pattern collapse.

The above object is fulfilled, according to this invention, by an antireflection film forming method for forming antireflection film on a substrate in advance of applying a resist solution to the substrate, the method comprising performing surface modifying treatment of the antireflection film for reducing a hydrogen bonding component of surface energy of the antireflection film formed on the substrate.

According to the invention, the surface modifying treatment reduces the hydrogen bonding component of surface energy of the antireflection film, thereby increasing the adhesion energy in water of the antireflection film and resist film. This inhibits a resist pattern collapse. The chemical composition of the antireflection film itself is not changed by the surface modifying treatment. Thus, the essential characteristics of the antireflection film are maintained intact.

In the invention noted above, the surface modifying treatment may include supplying the antireflection film with a gas including one of an aromatic compound, a silicon-containing aliphatic compound, and a mixture of an aromatic compound and a silicon-containing aliphatic compound, or an inert gas. Then, the surface modifying treatment is carried out effectively without changing the characteristics of the antireflection film.

The surface modifying treatment may include supplying the antireflection film with a liquid including one of an aromatic compound, a silicon-containing aliphatic com-pound, and a mixture of an aromatic compound and a silicon-containing aliphatic compound. Then, similarly to the above, the surface modifying treatment is carried out effectively without changing the characteristics of the antireflection film.

The method according to the invention may include a drying step for spinning the substrate coated with the antireflection film; and a heat-treating step for heat-treating the substrate after the drying step; wherein the surface modifying treatment is performed in time of the drying step or/and the heat-treating step. The surface modifying treatment performed when the antireflection film is formed can reduce the hydrogen bonding component of surface energy of the antireflection film effectively.

The method according to the invention may include a drying step for spinning the substrate coated with the antireflection film; a heat-treating step for heat-treating the substrate after the drying step; and a resist solution application preliminary step for performing the surface modifying treatment of the antireflection film coating the substrate after the heat-treating step. With the resist solution application preliminary step for performing the surface modifying treatment of the antireflection film, the hydrogen bonding component of surface energy of the antireflection film is reduced effectively.

The resist solution application preliminary step may be executed to perform the surface modifying treatment while heating the substrate. Then, the surface modifying treatment is carried out effectively.

The surface modifying treatment may be performed also in time of the drying step or/and the heat-treating step. Then, the hydrogen bonding component of the antireflection film can be further reduced.

In another aspect of the invention, a substrate treating apparatus is provided for forming antireflection film on a substrate in advance of applying a resist solution to the substrate, the apparatus comprising a film material supply device for supplying an antireflection film material to the substrate; and a modifying material supply device for supplying a predetermined one of a gas and a liquid to the antireflection film coating the substrate, to effect surface modifying treatment for reducing a hydrogen bonding component of surface energy of the antireflection film.

According to the invention, the modifying material supply device reduces the hydrogen bonding component of surface energy of the antireflection film, thereby increasing the adhesion energy in water of the antireflection film and resist film. This inhibits a resist pattern collapse. The chemical composition of the antireflection film itself is not changed by the surface modifying treatment. Thus, the essential characteristics of the antireflection film are maintained intact.

The apparatus according to the invention noted above may further comprise a spinning device for spinning the substrate; and a control device for controlling the film material supply device, the modifying material supply device and the spinning device to supply the predetermined one of the gas and the liquid to the antireflection film coating the substrate while spinning the substrate. The surface modifying treatment performed when the antireflection film is formed can reduce the hydrogen bonding component of surface energy of the antireflection film effectively.

In a further aspect of the invention, a substrate treating apparatus is provided for forming antireflection film on a substrate in advance of applying a resist solution to the substrate, the apparatus comprising a coating unit for applying an antireflection film material to the substrate to coat the substrate with the antireflection film; and a heat-treating unit for heat-treating the substrate coated with the antireflection film; wherein the coating unit includes a modifying material supply device for supplying a predetermined one of a gas and a liquid to the antireflection film coating the substrate, to effect surface modifying treatment for reducing a hydrogen bonding component of surface energy of the antireflection film.

The coating unit includes the modifying material supply device, whereby the surface modifying treatment is carried out immediately after the antireflection film is applied to the substrate. As a result, the hydrogen bonding component of surface energy of the antireflection film is reduced, thereby increasing the adhesion energy in water of the antireflection film and resist film. This inhibits a resist pattern collapse. The chemical composition of the antireflection film itself is not changed by the surface modifying treatment. Thus, the essential characteristics of the antireflection film are maintained intact.

In a still further aspect of the invention, a substrate treating apparatus is provided for forming antireflection film on a substrate in advance of applying a resist solution to the substrate, the apparatus comprising a coating unit for applying an antireflection film material to the substrate to coat the substrate with the antireflection film; and a heat-treating unit for heat-treating the substrate coated with the antireflection film; wherein the heat-treating unit includes a modifying material supply device for supplying a predetermined one of a gas and a liquid to the antireflection film coating the substrate, to effect surface modifying treatment for reducing a hydrogen bonding component of surface energy of the antireflection film.

In the above apparatus, the heat-treating unit includes the modifying material supply device, whereby the surface modifying treatment is carried out while heat-treating the substrate. As a result, the hydrogen bonding component of surface energy of the antireflection film is reduced, thereby increasing the adhesion energy in water of the antireflection film and resist film. This inhibits a resist pattern collapse. The chemical composition of the antireflection film itself is not changed by the surface modifying treatment. Thus, the essential characteristics of the antireflection film are maintained intact.

In yet another aspect of the invention, a substrate treating apparatus is provided for forming antireflection film on a substrate in advance of applying a resist solution to the substrate, the apparatus comprising a coating unit for applying an antireflection film material to the substrate to coat the substrate with the antireflection film; a heat-treating unit for heat-treating the substrate coated with the antireflection film; and a surface modifying unit for supplying a predetermined one of a gas and a liquid to the antireflection film coating the substrate heat-treated, to effect surface modifying treatment for reducing a hydrogen bonding component of surface energy of the antireflection film.

In the above apparatus, the surface modifying unit reduces the hydrogen bonding component of surface energy of the antireflection film, thereby increasing the adhesion energy in water of the antireflection film and resist film. This inhibits a resist pattern collapse. The chemical composition of the antireflection film itself is not changed by the surface modifying treatment. Thus, the essential characteristics of the antireflection film are maintained intact. Since the surface modifying unit is provided separately from the coating unit and heat-treating unit, the surface modifying treatment is performed efficiently on the antireflection film coating the substrate having undergone heat treatment.

In each of the above apparatus, the gas may be a gas including one of an aromatic compound, a silicon-containing aliphatic compound, and a mixture of an aromatic compound and a silicon-containing aliphatic compound, or an inert gas. Then, the surface modifying treatment is carried out effectively without changing the characteristics of the antireflection film.

In each of the above apparatus, the liquid may be a liquid including one of an aromatic compound, a silicon-containing aliphatic compound, and a mixture of an aromatic compound and a silicon-containing aliphatic compound. Then, similarly to the above, the surface modifying treatment is carried out effectively without changing the characteristics of the antireflection film.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIGS. 1A, 1B, 1C and 1D are schematic views showing steps of treating a substrate by an antireflection film forming method in Embodiment 1;

FIG. 2 is a table of comparison in respect of adhesion energy in water WBRI between Embodiment 1 and a case of forming antireflection film B without surface modifying treatment (comparative example);

FIGS. 3A, 3B, 3C and 3D are schematic views showing steps of treating a substrate by an antireflection film forming method in Embodiment 2;

FIG. 4 is a plan view showing an outline of a substrate treating apparatus;

FIG. 5 is a sectional view of a coating unit; and

FIG. 6 is a sectional view of a surface modifying unit.

### DESCRIPTION OF THE PREFERRED EMBODIMENTS

Preferred embodiments of this invention will be described in detail hereinafter with reference to the drawings. First, antireflection film forming methods in two embodiments will be described, and thereafter an apparatus in one embodiment suited for implementing these methods will be described.

### First Embodiment

Embodiment 1 of this invention will be described hereinafter with reference to the drawings.

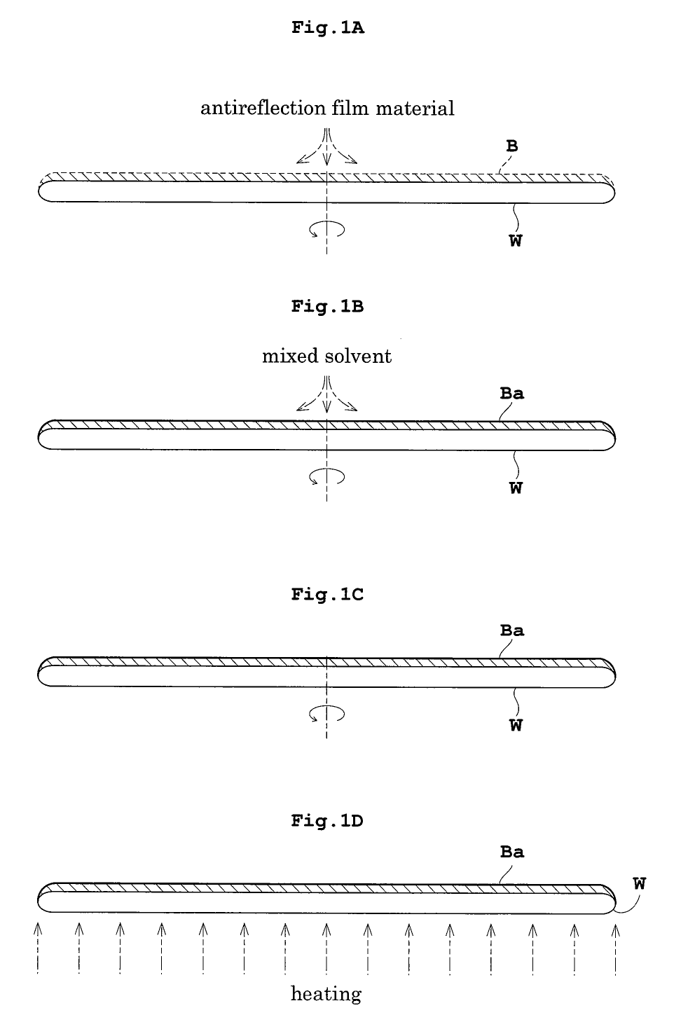

FIGS. 1A-1D are schematic views showing steps of treating a substrate by an antireflection film forming method in Embodiment 1.

<Coating Step>

As shown in FIG. 1A, an organic antireflection film material is supplied to the upper surface of a wafer W under treatment while the wafer W is spun in horizontal posture (spin coating). The antireflection film material spreads over the entire surface of wafer W, forming an antireflection film B on the wafer W. Subsequently, the supply of the antireflection film material is stopped. <Drying Step>

Then, as shown in FIG. 1B, while the spin of wafer W is continued, a mixed solvent of hexamethyldisilazane (hereinafter called simply HMDS) and xylene is supplied in a predetermined quantity to the upper surface of antireflection film B. This reduces a hydrogen bonding component of surface energy of antireflection film B. In this specification, this step is called the surface modifying step, and the antireflection film having undergone the surface modifying step is referred to as antireflection film Ba. The wafer W is maintained in the spinning state to dry the antireflection film Ba applied to the wafer W (FIG. 1C). Subsequently, the spin of wafer W is stopped. The treatment shown in FIGS. 1B and 1C corresponds to the drying step in this invention. <Heat-Treating Step>

Then, as shown in FIG. 1D, the wafer W is subjected to heat treatment. This completes formation of antireflection film Ba on the wafer W.

The above coating step, drying step and heat-treating step constitute a series of processes for forming the antireflection film Ba on the wafer W. Subsequently, a resist solution is spin-coated on the surface of antireflection film Ba formed on the wafer W, and is heat-treated, to form a resist film.

By supplying the mixed solvent to the antireflection film B as described above, the hydrogen bonding component of the surface energy of antireflection film B can be reduced. As a result of such surface modifying treatment, the adhesion energy of the antireflection film Ba and resist film in water can be increased.

This aspect will now be described in greater detail. Adhesion energy in water W_{BRI} of antireflection film Ba and resist film is a difference between adhesion energy in the atmosphere WBR of antireflection film B and resist film, and penetration energy of water W_{I} (Equation 1).
W_{BRI}=W_{BR}−W_{I} (1)

Adhesion energy in the atmosphere WBR is derived from Equation 2.
W_{BR}=2√(γ_{Bd}×γ_{Rd})+2√(γ_{Bp}×γ_{Rp})+2√(γ_{Bh}×γ_{Rh}) (2)
where γ_{Bd} and γ_{Rd} are variance components of surface energies γ_{B} and γ_{R} of antireflection film B and resist film, γ_{Bp} and γ_{Rp} are polar components of surface energies γ_{B} and γ_{R} of antireflection film B and resist film, and γ_{Bh} and γ_{Rh} are hydrogen bonding components of surface energies γ_{B} and γ_{R} of antireflection film B and resist film. Therefore, surface energies γ_{B} and γ_{R} of antireflection film B and resist film can be expressed by Equation 3 and Equation 4.
γ_{B}=γ_{Bd}+γ_{Bp}+γ_{Bh} (3)
γ_{R}=γ_{Rd}+γ_{Rp}+γ_{Rh} (4)

Similarly, penetration energy of water W_{I} is determined from penetration energy of water W_{WB} and antireflection film B, penetration energy of water W_{WR} and resist film, and surface energy of water yw (Equation 5).
W_{I}=W_{WB}+W_{WR}−2γ_{w} (5)

Surface energy of water γw is a sum of variance component γ_{wd}, polar component γwp, and hydrogen bonding component γ_{wh}. Values of the components γ_{wd}, γ_{WP} and γ_{wh} are as shown in Equations 6 to 8, in which hydrogen bonding component γ_{Wh} has a remarkably large value:
γ_{Wd}=29.1 (6)
γ_{WP}=1.3 (7)
γ_{Wh}=42.4 (8)

Thus, a reduction in hydrogen bonding component γ_{Bh} of surface energy γ_{B} of antireflection film B will reduce adhesion energy in the atmosphere W_{BR}, but will reduce penetration energy of water W_{I} to a far greater extent. As a result, adhesion energy in water W_{BRI} will increase.

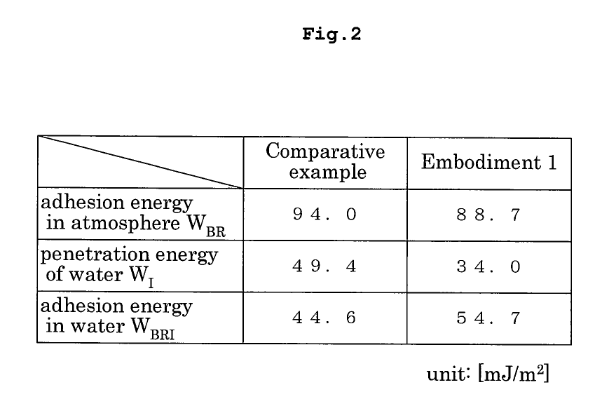

FIG. 2 refers. FIG. 2 is a table of comparison in respect of adhesion energy in water W_{BRI} between the case of forming antireflection film Ba by the antireflection film forming method shown in Embodiment 1 described above (Embodiment 1) and a case of forming antireflection film B without surface modifying treatment (comparative example). The values shown in FIG. 2 are calculated based on results of measuring surface energies of the antireflection film, resist film and water.

As shown in FIG. 2, the value of adhesion energy in water W_{BRI} was 54.7 mJ/m² for Embodiment 1, and 44.6 mJ/m² for the comparative example. Thus, it has been confirmed that Embodiment 1 increased adhesion energy in water W_{BRI} by about 20% over the comparative example.

By performing the surface modifying treatment on the antireflection film B to reduce hydrogen bonding component γ_{Bh} of surface energy γ_{B} of antireflection film B, adhesion energy in water W_{BRI} of antireflection film Ba and resist film can be increased. This inhibits a resist pattern collapse during a developing process performed subsequently.

Since the surface modifying treatment is performed while the antireflection film B is formed, hydrogen bonding component γ_{Bh} of surface energy γ_{B} of antireflection film Ba is reduced effectively.

The chemical composition of antireflection film Ba itself having undergone the surface modifying treatment is not different from the antireflection film B before the surface modifying treatment. Thus, the essential characteristics of antireflection film B are maintained.

Embodiment 1 described above may be modified as follows:

(1) In Embodiment 1 described above, the mixed solvent of HMDS and xylene is supplied to the antireflection film B. Instead, only HMDS or only xylene may be supplied. HMDS is not limitative, but may be replaced, as appropriate, by a silicon-containing aliphatic compound such as hexamethyltrisilazane. Xylene may be replaced, as appropriate, by an aromatic compound such as toluene or benzene. A different, selected silicon-containing aliphatic compound and a different, selected aromatic compound may be mixed for use.

(2) Embodiment 1 described above supplies the mixed solvent, which is liquid, to the upper surface of antireflection film B. It is possible to supply, instead, a gas including a silicon-containing aliphatic compound such as HMDS or hexamethyltrisilazane, a gas including an aromatic compound such as xylene, toluene or benzene, or a gas including a silicon-containing aliphatic compound and an aromatic compound. It is also possible to supply only an inert gas such as nitrogen, helium or argon. Such gases are also effective to reduce the hydrogen bonding component of antireflection film B.

(3) In Embodiment 1 described above, the surface modifying treatment is carried out in time of drying the antireflection film B. This is not limitative. The surface modifying treatment may be performed during the heat-treating step, for example. Specifically, when heat-treating the wafer W, the mixed solvent may be supplied in a predetermined quantity to the antireflection film B. Further, a selected one of the gases set out in paragraph (2) above may be supplied, to heat-treat the wafer W in the gas atmosphere. This can also effect surface modifying treatment while forming the antireflection film B. The surface modifying treatment may be performed during each of the drying step and heat-treating step.

(4) Embodiment 1 uses an organic antireflection film material, which may be replaced by an inorganic antireflection film material. A CVD apparatus or PVD apparatus may be used to form antireflection film, as appropriate.

### Second Embodiment

Embodiment 2 of this invention will be described hereinafter with reference to the drawings.

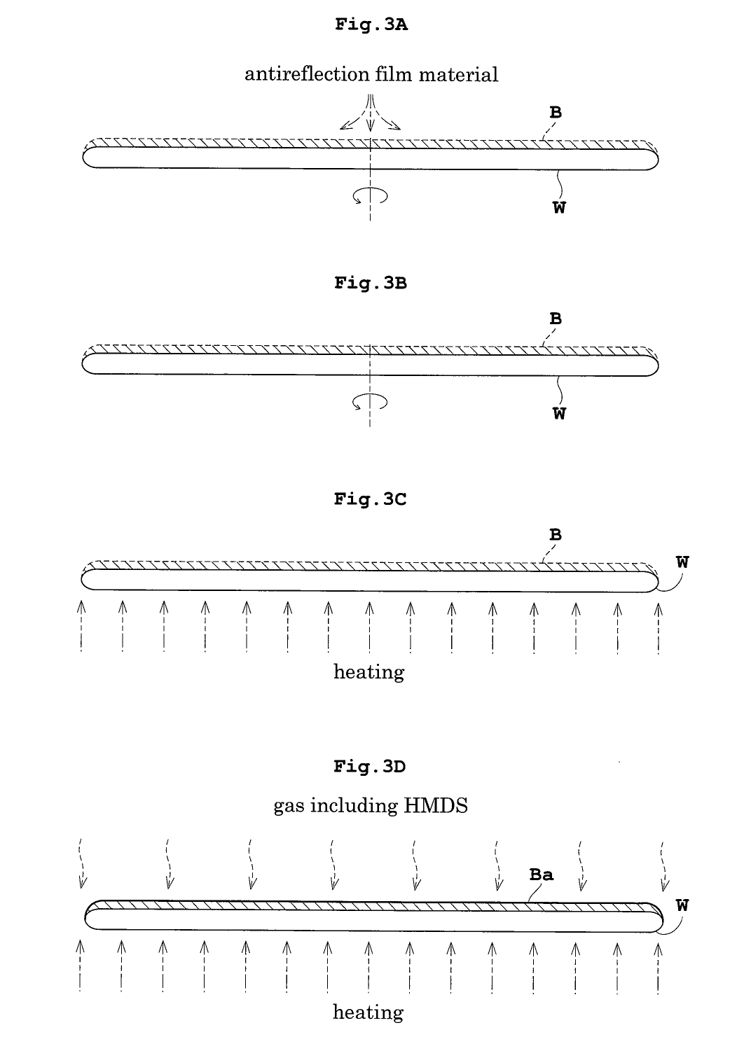

FIGS. 3A-3D are schematic views showing steps of treating a substrate by an antireflection film forming method in Embodiment 2. Treating steps similar to those in Embodiment 1 will be described only briefly.

<Coating Step>

As shown in FIG. 3A, an antireflection film material is spin-coated on the wafer W under treatment.

<Drying Step>

As shown in FIG. 3B, the wafer W is maintained in the spinning state to dry antireflection film B coating the wafer W. No surface modifying treatment is performed during the drying step.

<Heat-Treating Step>

As shown in FIG. 3C, the wafer W is subjected to heat treatment.

<Resist Solution Application Preliminary Step>

Further, as shown in FIG. 3D, the wafer W is heat-treated while supplying a gas including HMDS to the upper surface of antireflection film B coating the wafer W (which corresponds to the surface modifying treatment in this invention). As a result, the antireflection film B is modified into antireflection film Ba on the wafer W, with reduced hydrogen bonding component γ_{Bh} of its surface energy γ_{B}.

In Embodiment 2, the above coating step, drying step and heat-treating step constitute a series of processes for forming the antireflection film Ba on the wafer W. Subsequently, a resist film is formed on the wafer W.

With the above resist solution application preliminary step for supplying the gas including HMDS to the antireflection film B, the hydrogen bonding component γ_{Bh} of surface energy γ_{B} of antireflection film B can be reduced. As a result, adhesion energy in water W_{BRI} of antireflection film Ba and resist film can be increased. This inhibits a resist pattern collapse during a developing process performed subsequently.

Embodiment 2 described above may be modified as follows:

(1) In Embodiment 2 described above, the wafer W is heat-treated in the resist solution application preliminary step. This is not limitative. For example, the gas including HMDS may be supplied while spinning the wafer W.

(2) In Embodiment 2 described above, the gas including HMDS is supplied to the antireflection film B. This is not limitative. It is possible to use, for example, a gas including hexamethyltrisilazane or other silicon-containing aliphatic compound, a gas including an aromatic compound such as xylene, toluene or benzene, or a gas including such silicon-containing aliphatic compound and aromatic compound. It is also possible to supply only an inert gas such as nitrogen, helium or argon.

Instead of the above gas, a liquid may be supplied. The liquid may, as appropriate, comprise a silicon-containing aliphatic compound such as HMDS or hexamethyltrisilazane, an aromatic compound such as xylene, toluene or benzene, or a mixture of the silicon-containing aliphatic compound and aromatic compound.

(3) Embodiment 2 described above includes the resist solution application preliminary step for performing the surface modifying treatment. The surface modifying treatment may be performed also in time of the drying step or heat-treating step.

### Third Embodiment

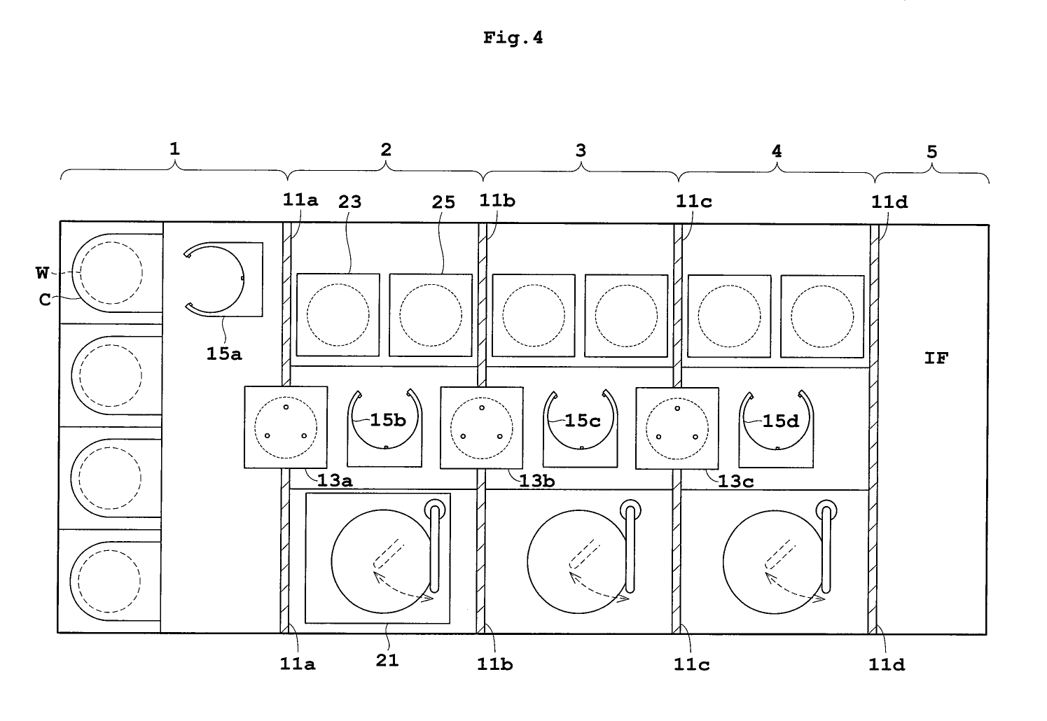

Next, a substrate treating apparatus suited to implement above Embodiments 1 and 2 will be described with reference to the drawings. FIG. 4 is a schematic plan view of the substrate treating apparatus.

The substrate treating apparatus in Embodiment 3 is constructed for forming antireflection film and resist film on wafers W under treatment, and performing chemical treatment such as development on exposed wafers W.

The substrate treating apparatus in this embodiment includes an indexer block 1 for fetching wafers W from cassettes C each containing a plurality of wafers W in multiple stages, and depositing wafers W in the cassettes C, an antireflection film forming block 2 for forming antireflection film on the wafers W, a resist film forming block 3 for forming resist film on the wafers W, a developing block 4 for developing the wafers W, and an interface block 5 for delivering and receiving the wafers W to/from an exposing apparatus (e.g. stepper) STP which is an external apparatus separate from the substrate treating apparatus. Atmosphere shielding partitions 11a-11d are formed between adjacent blocks 1-5. The partitions 11a-11c have openings formed therein and defining substrate tables 13a-13c for receiving wafers W, respectively. The blocks 1-4 include main transport mechanisms 15a- 15d for transporting wafers W, respectively. The interface block 5 also includes a main transport mechanism not shown.

The antireflection film forming block 2 will be described. The antireflection film forming block 2 includes, besides the main transport mechanism 15b, coating units 21 for applying an antireflection film material to wafers W to coat the wafers W with antireflection film, heat-treating units 23 for heat-treating the wafers W coated with the antireflection film, and surface modifying units 25 for performing surface modifying treatment of the antireflection film on the wafers W. These coating units 21, heat-treating units 23 and surface modifying units 25, respectively, are arranged vertically. The main transport mechanism 15b transfers the wafers W to and from these treating units 21, 23 and 25 and substrate tables 13a and 13b.

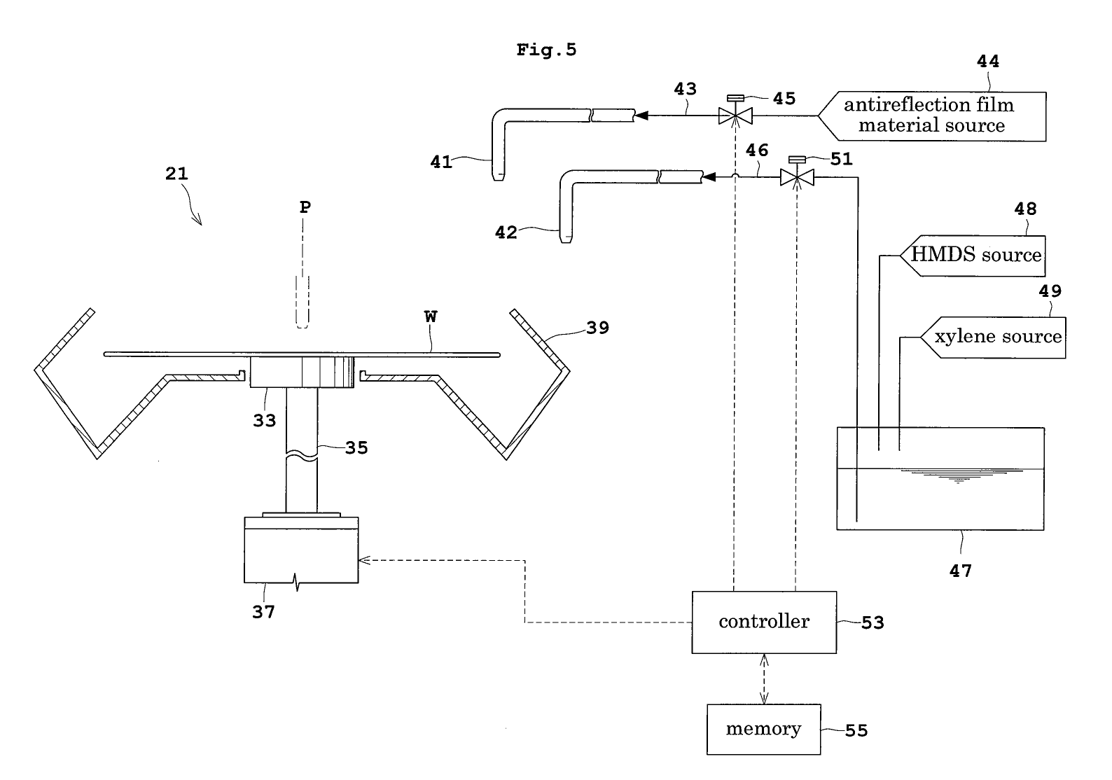

The coating units 21 will be described with reference to FIG. 5. A spin chuck 33, which corresponds to the spinning device in this invention, sucks a central region on the lower surface of each wafer W and holds the wafer W in horizontal posture. A rotary shaft 35 of a motor 37 is interlocked to the bottom of the spin chuck 33. The spin chuck 33 is surrounded by a vertically movable scatter preventive cup 39. The scatter preventive cup 39 has a function to guide downward and collect treating solutions such as a developer scattering around from outer edges of the wafer W.

Arranged laterally of the scatter preventive cup 39 are a first nozzle 41 for supplying the antireflection film material to the wafer W, and a second nozzle 42 for supplying a predetermined liquid described hereinafter to the wafer W. Each of the first and second nozzles 41 and 42 is movable by an independent moving mechanism (not shown) between a “supply position” (shown in two-dot chain lines in FIG. 5) adjacent a spin center P of the wafer W and a “standby position” (shown in solid lines in FIG. 5) offset from the wafer W.

The first nozzle 41 is connected through piping 43 to a film material source 44 storing the antireflection film material. The piping 43 has a switch valve 45 mounted thereon for controlling supply and stopping of the antireflection film material. The second nozzle 42 is connected through piping 46 to a mixing tank 47. The mixing tank 47 is in communication with an HMDS source 48 and a xylene source 49. A mixed solvent of HMDS and xylene (hereinafter called simply the mixed solvent) is formed in the mixing tank 47. The piping 46 has a switch valve 51 mounted thereon for controlling supply and stopping of the mixed solvent. The first nozzle 41 corresponds to the film material supply device in this invention. The second nozzle 42 corresponds to the modifying material supply device in this invention.

A controller 53 controls the above motor 37, switch valves 45 and 51 and moving mechanisms (not shown) of the first and second nozzles 41 and 42. Control timing and so on of each component are determined by referring to a memory 55 storing recipes specifying procedures.

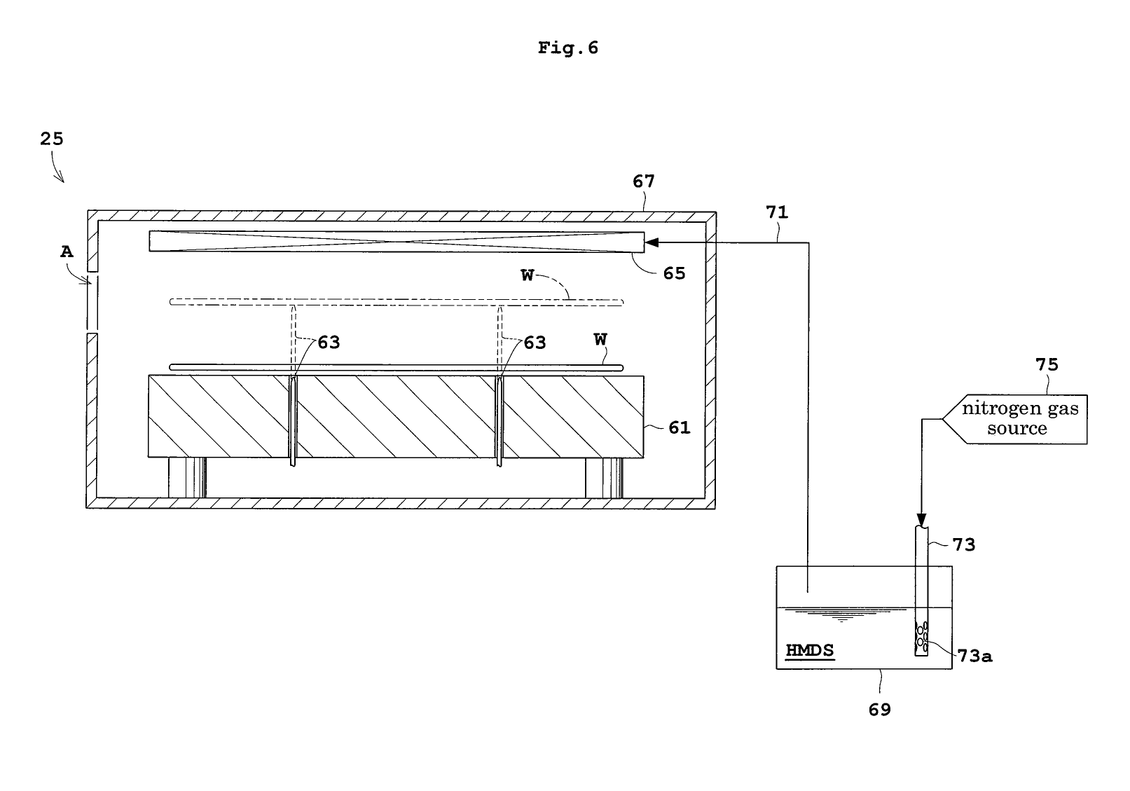

Next, the surface modifying units 25 will be described with reference to FIG. 6 (the heat-treating units 23 will be described hereinafter). Each surface modifying unit 25 includes a heat-treating plate 61 having a heating element (not shown), support pins 63 extending through the heat-treating plate 61 to be vertically movable relative thereto, a gas outlet 65 disposed above the heat-treating plate 61 for blowing off a predetermined gas, and a case 67 housing the heat-treating plate 61, support pins 63 and gas outlet 65. The case 57 has an opening A for loading and unloading wafers W. The gas outlet 65 is connected through piping 71 to a bubbling tank 69 storing HMDS. A bubble tube 73 extends into the bubbling tank 69, with a forward end thereof immersed into the HMDS solution. A plurality of jet bores 73a are formed in the forward end of bubble tube 73. The other end of bubble tube 73 is connected to a nitrogen gas source 75. As nitrogen gas is blown off from the jet bores 73a, a gas mixture of HMDS and nitrogen is produced in the bubbling tank 69.

The heat-treating units 23 will be described. Each heat-treating unit 23 corresponds to the above surface modifying unit 25 with the gas outlet 65 omitted therefrom. Thus, each heat-treating unit 23 includes a heat-treating plate and associated components, but not components corresponding to the gas outlet 65, bubbling tank 69 and so on. In the following description, for expediency, the heat-treating plate and so on of the heat-treating unit 23 are affixed with the same reference numerals as those of the surface modifying unit 25.

The heat-treating unit 23 and surface modifying unit 25 further include controllers, valves and so on, not shown, to control output of the heating elements attached to the heat-treating plates 61, supply to the bubbling tank 69 of the nitrogen gas, and the quantity of gas mixture blown off from the gas outlet 65.

Next, operation of the substrate treating apparatus in Embodiment 3 will be described. The description will be made separately for Operation Example 1 corresponding to Embodiment 1 and Operation Example 2 corresponding to Embodiment 2.

<Operation Example 1>

The controller 53 of the coating unit 21 accesses the memory 55, and refers to a recipe for Embodiment 1 described hereinbefore. While driving the motor 37 to spin a wafer W, the first nozzle 41 is moved to the supply position to supply the antireflection film material in a predetermined quantity to the wafer W. Subsequently, the supply of the antireflection film material is stopped, and the first nozzle 41 is moved back to the standby position. The wafer W is now coated with antireflection film.

Then, with the wafer W kept spinning, the second nozzle 42 is moved to the supply position to supply the mixed solvent to the wafer W (surface modifying treatment). Subsequently, the, supply of the mixed solvent is stopped and the second nozzle 42 is moved back to the standby position. The wafer W is kept spinning to dry the antireflection film coating the wafer W.

Then, the main transport mechanism 15b transports the wafer W from the coating unit 21 to one of the heat-treating units 23. The wafer W loaded into the heat-treating unit 23 is placed on the heat-treating plate 61 adjusted to a predetermined temperature. This state is maintained for a predetermined time to heat-treat the wafer W. This completes formation of the antireflection film on the wafer W.

The main transport mechanism 15b unloads the wafer W from the heat-treating unit 23, and places the wafer W on the substrate table 13b between the antireflection film forming block 2 and resist film forming block 3. In the resist film forming block 3, resist film is formed on the antireflection film formed on the wafer W. Then, the wafer W is transferred through the interface block 5 to the separate, external exposing apparatus (stepper) STP to be exposed therein. Upon return from the exposing apparatus STP, the wafer W is developed in the development block 4, to resolve the resist pattern.

As described above, the controller 53 carries out controls to perform the surface modifying treatment on the antireflection film when drying the wafer W. Thus, the antireflection film forming method shown in Embodiment 1 can be performed effectively. This inhibits a resist pattern collapse during the developing process.

The coating unit 21 includes the first nozzle 41 and second nozzle 42, whereby the coating treatment for coating the wafer W with the antireflection film is followed quickly by the surface modifying treatment. Thus, the surface modifying treatment can be performed effectively.

<Operation Example 2>

The controller 53 of the coating unit 21 accesses the memory 55, and refers to a recipe for Embodiment 2 described hereinbefore. While driving the motor 37 to spin a wafer W, the first nozzle 41 is moved to the supply position to supply the antireflection film material in a predetermined quantity to the wafer W. Subsequently, the supply of the antireflection film material is stopped, and the first nozzle 41 is moved back to the standby position. The wafer W is now coated with antireflection film.

Subsequently, the wafer W is kept spinning for a predetermined time to dry the antireflection film coating the wafer W.

Then, the main transport mechanism 15b transports the wafer W from the coating unit 21 to one of the heat-treating units 23. In the heat-treating unit 23, the wafer W loaded therein is heat-treated.

After the heat treatment, the main transport mechanism 15b transports the wafer W from the heat-treating unit 23 to one of the surface modifying units 25. In the surface modifying unit 25, the wafer W is heat-treated in the atmosphere of the gas mixture of HMDS and nitrogen. This effects the surface modifying treatment of the antireflection film to complete formation of the antireflection film.

The main transport mechanism 15b unloads the wafer W from the surface modifying unit 25, and places the wafer W on the substrate table 13b between the antireflection film forming block 2 and resist film forming block 3. Then, the resist film forming process and the subsequent series of processes are carried out.

As described above, the controller 53 carries out controls to perform the surface modifying treatment on the antireflection film coating the wafer W after the heat treatment. Thus, the antireflection film forming method shown in Embodiment 2 can be performed effectively. This inhibits a resist pattern collapse during the developing process.

The surface modifying units 25 are provided separately from the coating units 21 and heat-treating units 23. This enables the surface modifying treatment to be carried out efficiently on the antireflection film coating the wafer W after the heat treatment.

The invention is not limited to the embodiments described above, but may be modified as follows:

(1) In Embodiment 3 described above, the second nozzle 42 corresponding to the modifying material supply device in this invention supplies the mixed medium of HMDS and xylene. The mixed medium may be changed to a different liquid or gas, as appropriate, as described in Embodiments 1 and 2. For supplying a gas, the coating unit 21 may be modified to include a construction corresponding to the bubbling tank 69 of the surface modifying units 25.

(2) In Embodiment 3 described above, the mixed solvent is prepared in the mixing tank 47, and supplied to the wafer W from the single, second nozzle 42. This is not limitative. For example, a plurality of nozzles may be arranged for supplying different liquids, so that a mixed solvent may be prepared on the wafer W.

(3) In Embodiment 3 described above, each coating unit 21 includes the second nozzle 42. This is not limitative. That is, the second nozzle 42 may be omitted from a substrate treating apparatus that performs surface modifying treatment in the units other than the coating units 21, such as the surface modifying units 25.

(4) In Embodiment 3 described above, the heat-treating units 23 are constructed to perform only heat treatment of wafers W, without performing the surface modifying treatment of antireflection film. This is not limitative. Each heat-treating unit 23 may include a construction corresponding to the gas outlet 65 of the surface modifying unit 25, for supplying a predetermined gas to a wafer W in the heat-treating unit 23. Each heat-treating unit 23 may include a construction corresponding to the second nozzle 42 of the coating unit 21, for supplying a predetermined liquid to the wafer W. In these cases, the construction in each heat-treating unit 23 corresponding to the gas outlet 65 or to the second nozzle 42 corresponds to the modifying material supply device in this invention.

(5) In Embodiment 3 described above, the gas outlet 65 of each surface modifying unit 25 supplies a gas mixture. The gas mixture may be replaced by the predetermined gas or liquid shown in Embodiments 1 and 2, as appropriate.

(6) Embodiment 3 described above includes the surface modifying units 25. The surface modifying units 25 may be omitted from a substrate treating apparatus that performs the surface modifying treatment in the coating units 21 or heat-treating units 23.

(7) Embodiment 3 described above includes the spin chuck 33 for supporting the central region on the lower surface of each wafer W by suction. This is not limitative. It is possible to employ, for example, a substrate support mechanism (which is called a mechanical chuck) having a plurality of support pins 63 arranged peripherally of a base member for contacting and supporting edges of each wafer W.

(8) The components described in the foregoing embodiments and modifications may be appropriately combined to provide an antireflection film forming method and a substrate treating apparatus.

This invention may be embodied in other specific forms without departing from the spirit or essential attributes thereof and, accordingly, reference should be made to the appended claims, rather than to the foregoing specification, as indicating the scope of the invention.

What is claimed is:

1. An antireflection film forming method for forming antireflection film on a substrate in advance of applying a resist solution to the substrate, said method comprising:
performing surface modifying treatment of said antireflection film for reducing a hydrogen bonding component of surface energy of the antireflection film formed on the substrate.

2. A method as defined in claim 1, wherein said surface modifying treatment includes supplying said antireflection film with a gas including one of an aromatic compound, a silicon-containing aliphatic compound, and a mixture of an aromatic compound and a silicon-containing aliphatic compound, or an inert gas.

3. A method as defined in claim 1, wherein said surface modifying treatment includes supplying said antireflection film with a liquid including one of an aromatic compound, a silicon-containing aliphatic compound, and a mixture of an aromatic compound and a silicon-containing aliphatic compound.

4. A method as defined in claim 1, including:
a drying step for spinning the substrate coated with the antireflection film; and
a heat-treating step for heat-treating the substrate after said drying step;
wherein said surface modifying treatment is performed in time of said drying step or/and said heat-treating step.

5. A method as defined in claim 1, including:
a drying step for spinning the substrate coated with the antireflection film;
a heat-treating step for heat-treating the substrate after said drying step; and
a resist solution application preliminary step for performing said surface modifying treatment of said antireflection film coating the substrate after said heat-treating step.

6. A method as defined in claim 5, wherein said resist solution application preliminary step is executed to perform said surface modifying treatment while heating the substrate.

7. A method as defined in claim 5, wherein said surface modifying treatment is performed also in time of said drying step or/and said heat-treating step.

8. A substrate treating apparatus for forming antireflection film on a substrate in advance of applying a resist solution to the substrate, said apparatus comprising:
a film material supply device for supplying an antireflection film material to the substrate; and
a modifying material supply device for supplying a predetermined one of a gas and a liquid to the antireflection film coating the substrate, to effect surface modifying treatment for reducing a hydrogen bonding component of surface energy of the antireflection film.

9. An apparatus as defined in claim 8, further comprising:
a spinning device for spinning the substrate; and
a control device for controlling said film material supply device, said modifying material supply device and said spinning device to supply said predetermined one of the gas and the liquid to said antireflection film coating the substrate while spinning the substrate.

10. An apparatus as defined in claim 8, wherein said gas is a gas including one of an aromatic compound, a silicon-containing aliphatic compound, and a mixture of an aromatic compound and a silicon-containing aliphatic compound, or an inert gas.

11. An apparatus as defined in claim 8, wherein said liquid is a liquid including one of an aromatic compound, a silicon-containing aliphatic compound, and a mixture of an aromatic compound and a silicon-containing aliphatic compound.

12. A substrate treating apparatus for forming antireflection film on a substrate in advance of applying a resist solution to the substrate, said apparatus comprising:
a coating unit for applying an antireflection film material to the substrate to coat the substrate with the antireflection film; and
a heat-treating unit for heat-treating the substrate coated with the antireflection film;
wherein said coating unit includes a modifying material supply device for supplying a predetermined one of a gas and a liquid to the antireflection film coating the substrate, to effect surface modifying treatment for reducing a hydrogen bonding component of surface energy of the antireflection film.

13. An apparatus as defined in claim 12, wherein said gas is a gas including one of an aromatic compound, a silicon-containing aliphatic compound, and a mixture of an aromatic compound and a silicon-containing aliphatic compound, or an inert gas.

14. An apparatus as defined in claim 12, wherein said liquid is a liquid including one of an aromatic compound, a silicon-containing aliphatic compound, and a mixture of an aromatic compound and a silicon-containing aliphatic compound.

15. A substrate treating apparatus for forming antireflection film on a substrate in advance of applying a resist solution to the substrate, said apparatus comprising:
a coating unit for applying an antireflection film material to the substrate to coat the substrate with the antireflection film; and
a heat-treating unit for heat-treating the substrate coated with the antireflection film;
wherein said heat-treating unit includes a modifying material supply device for supplying a predetermined one of a gas and a liquid to the antireflection film coating the substrate, to effect surface modifying treatment for reducing a hydrogen bonding component of surface energy of the antireflection film.

16. An apparatus as defined in claim 15, wherein said gas is a gas including one of an aromatic compound, a silicon-containing aliphatic compound, and a mixture of an aromatic compound and a silicon-containing aliphatic compound, or an inert gas.

17. An apparatus as defined in claim 15, wherein said liquid is a liquid including one of an aromatic compound, a silicon-containing aliphatic compound, and a mixture of an aromatic compound and a silicon-containing aliphatic compound.

18. A substrate treating apparatus for forming antireflection film on a substrate in advance of applying a resist solution to the substrate, said apparatus comprising:
a coating unit for applying an antireflection film material to the substrate to coat the substrate with the antireflection film;
a heat-treating unit for heat-treating the substrate coated with the antireflection film; and
a surface modifying unit for supplying a predetermined one of a gas and a liquid to the antireflection film coating the substrate heat-treated, to effect surface modifying treatment for reducing a hydrogen bonding component of surface energy of the antireflection film.

19. An apparatus as defined in claim 18, wherein said gas is a gas including one of an aromatic compound, a silicon-containing aliphatic compound, and a mixture of an aromatic compound and a silicon-containing aliphatic compound, or an inert gas.

20. An apparatus as defined in claim 18, wherein said liquid is a liquid including one of an aromatic compound, a silicon-containing aliphatic compound, and a mixture of an aromatic compound and a silicon-containing aliphatic compound.
